(19) United States
(12) Patent Application Publication
(10) Pub. No.: US 2008/0214213 A1
(43) Pub. Date: Sep. 4, 2008

(54) DETERMINING LOCATIONS OF MOBILE STATIONS IN WIRELESS NETWORKS

(76) Inventors: Kamran Etemad, Potomac, MD (US); Muthaiah Venkatachalam, Beaverton, OR (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/754,864

(22) Filed: May 29, 2007

Related U.S. Application Data
(60) Provisional application No. 60/892,798, filed on Mar. 2, 2007.

(51) Int. Cl. H04Q 7/20

(52) U.S. Cl. 455/456.6

(57) ABSTRACT

Wireless network methods and apparatuses that may determine and provide, in real-time, the geographical locations of mobile stations of the wireless network are described herein. In one implementation, in order to determine the location of a mobile station (MS), the MS may obtain from a navigation service a decryption key to decrypt encrypted location information of multiple base station's (BS's) in its local area. The encrypted location information of the BS may then be decrypted and based at least in part on the recovered location information of the BS, determine the location of the MS. In another implementation, in order to determine and provide the location of an MS of a wireless network, a combination of location agents, location controller, and a location server may be employed to determine and provide the current location of the MS to requesting authorized clients.

### CROSS REFERENCE TO RELATED APPLICATIONS

The present application claims priority to U.S. Provisional Patent Application No. 60/892,798 filed Mar. 2, 2007 entitled, “LOCATION BASED SERVICES FOR WIMAX NETWORK.”

### TECHNICAL FIELD

Embodiments of the present invention relate to the field of wireless communication systems, more specifically, to methods and apparatuses for providing mobile station location services.

### BACKGROUND

As wireless devices become more and more popular at offices, homes, schools, and so forth, users of such devices demand more functionality from such devices in order to meet the needs of, for example, constantly evolving user and/or network applications. Further, in some instances, regulatory and/or industry groups are or will be mandating that such wireless devices, as well as wireless networks, provide certain functionalities and services. For example, in the future, the ability to provide real-time geographical locations of wireless devices of wireless networks may be required in order to meet emergency/911 requirements associated with mobile voice over Internet Protocol (VoIP) applications. A wireless device, which may be referred to as a mobile station (MS), may have various form factors including, for example, a desktop computer, a laptop computer, a handheld computer, a tablet computer, a cellular telephone, a pager, an audio and/or video player (e.g., an MP3 player or a DVD player), a gaming device, a video camera, a digital camera, a navigation device (e.g., a GPS device), a wireless peripheral (e.g., a printer, a scanner, a headset, a keyboard, a mouse, etc.), a medical device (e.g., a heart rate monitor, a blood pressure monitor, etc.), and so forth.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 illustrates a wireless network, in accordance with various embodiments of the present invention;

FIG. 2 illustrates how information may be exchanged between a mobile station, a serving base station, and AAA (authentication, authorization, and accounting), in accordance with various embodiments of the present invention;

FIG. 3 illustrates an exemplary communication network, in accordance with various embodiments of the present invention;

FIG. 4A illustrates an exemplary network device that may host or be adapted to act as a location agent, in accordance with various embodiments of the present invention;

FIG. 4B illustrates an exemplary network device that may host or be adapted to act as a location controller, in accordance with various embodiments of the present invention;

FIG. 4C illustrates an exemplary network device that may host or be adapted to act as a location server, in accordance with various embodiments of the present invention;

FIG. 5 illustrates an exemplary WiMAX network, in accordance with various embodiments of the present invention;

FIG. 6 illustrates a process for determining a location of a mobile station of a wireless network, in accordance with various embodiments of the present invention;

FIG. 7 illustrates a high level call flow for initiating mobile station (MS) location determination, internal triggers, and reports, in accordance with various embodiments of the present invention;

FIG. 8 illustrates how a location server is updated with the identity of the serving location controller for an MS when the MS is in active mode, in accordance with various embodiments of the present invention; and

FIG. 9 illustrates how a location server is updated with the identity of the serving location controller for an MS when the MS is in idle mode, in accordance with various embodiments of the present invention.

### DETAILED DESCRIPTION OF ILLUSTRATIVE EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

For the purposes of the instant description, the phrase “A/B” means A or B. For the purposes of the instant description, the phrase “A and/or B” means “(A), (B), or (A and B).” For the purposes of the instant description, the phrase “at least one of A, B and C” means “(A), (B), (C), (A and B), (A and C), (B and C) or (A, B and C).” For the purposes of the instant description, the phrase “(A)B” means “(B) or (AB),” that is, A is an optional element.

The description may use the phrases “in various embodiments,” or “in some embodiments,” which may each refer to one or more of the same or different embodiments. Furthermore, the terms “comprising,” “including,” “having,” and the like, as used with respect to embodiments of the present invention, are synonymous.

According to various embodiment of the invention, wireless network methods and apparatuses are provided that may determine and provide, in real-time, the geographical locations of mobile stations of the wireless network. In some embodiments, the wireless network may be an Internet Protocol (IP) based wireless access network such as a Worldwide Interoperability for Microwave Access (WiMAX) network in which the wireless devices of the wireless network operate in accordance with the Institute of Electrical and Electronic Engineers (IEEE) std. 802.16-2004 (published Sep. 18, 2004), the IEEE std. 802.16e (published Feb. 28, 2006), the IEEE std. 802.16f (published Dec. 1, 2005), and/or variations and evolutions of these standards. Alternatively, the wireless network may be other types of wireless networks such as a wireless local area network (WLAN) in which the wireless devices of the network operate in accordance with IEEE 802.11x standards including, for example, IEEE 802.11a standard (IEEE std. 802.11a, published 1999) or IEEE 802.11b standard (IEEE std. 802.11b, published 1999), and/or variations and evolutions of these standards. In some embodiments of the present invention, in order to provide the geographical locations (or simply “locations”) of mobile stations, various network devices such as location agents, location controllers, and location servers may be employed as will be described in greater detail herein.

Currently, there are a number of techniques that may be employed in order to determine the location of a wireless device, such as a mobile station of a wireless network. These techniques typically involve the use of some sort of triangulation method for determining the location of the mobile station. Examples of such techniques include, for example, Differential Time of Arrival (DToA), Angle of Arrival (AoA) and so forth.

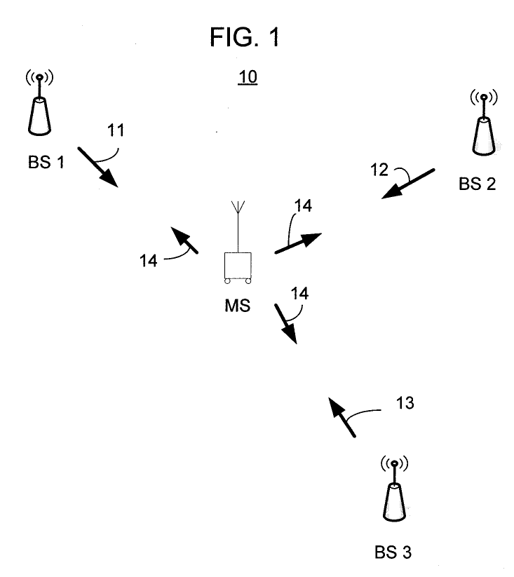

FIG. 1 illustrates a wireless network in accordance with various embodiments of the present invention. For illustrative purposes and for ease of understanding, the wireless network 10 is depicted as including only a single mobile station (MS) and three base stations (BS1, BS2, and BS3) though in alternative embodiments, the network 10 may include multiple mobile stations and greater number of base stations than depicted. For the embodiments, only one of the three base stations (BS1, BS2, and BS3) may actually be the serving base station that will service the MS while the other two base stations may simply be neighboring base stations (i.e., those base stations that are located near or in the neighborhood of the MS). Further, if the MS relocates to a different location, then another base station may become the serving base station for the MS.

In order to determine the location of the MS, in some embodiments of the present invention, each of the three base stations (BS1, BS2, and BS3) may broadcast to the MS, downlink signals 11, 12, and 13. In particular, each of the base stations may individually broadcast downlink signals 11, 12, and 13 that may each be measured at the MS. Using the measurements made at the MS and if the locations of each of the base stations (BS1, BS2, and BS3) are known, then by employing, for example, one of the triangulation techniques described above, the location of the MS may be determined. Note again that, in accordance with various embodiments of the present invention, in addition to the measurements of the downlink signals, the locations of each of the base stations (BS1, BS2, and BS3) need to be specified in order to determine the location of the MS.

For instance, in a simple example, if the exact locations of each of the base stations (BS1, BS2, and BS3) are known, then one would simply measure how long it takes for signals from each of the base stations (BS1, BS2, and BS3) to reach the MS. The time it takes for a signal transmitted by a base station to reach the MS may be used in order to determine how far away the MS is to that base station. With three base stations sending signals, and the MS knowing the exact geographical locations of each of the base stations, one could triangulate the results in order to obtain the exact location of the MS.

In alternative embodiments of the present invention, however, uplink signals 14 transmitted by the MS and received by the base stations (BS1, BS2, and BS3) may be measured at each of the base stations (BS1, BS2, and BS3). The location of the MS may then be determined based on the measurements made at each of the base stations (BS1, BS2, and BS3) if the locations of each of the base stations (BS1, BS2, and BS3) are known as before.

In some embodiments of the present invention, the location or locations of an MS of a wireless network may be determined at different points in time with minimal interaction with the wireless network. In alternative embodiments, however, the wireless network may have a relatively significant role in the determination of the location of the MS. Both approaches will be described in greater herein.

In accordance with various embodiments of the present invention, and as briefly described above, the location or locations of an MS of a wireless network may be determined at the MS with minimal interaction with the wireless network. For these embodiments, an MS may compute or calculate its own location by measuring downlink signals broadcasted by base stations, such as the serving base station and other neighboring base stations, and based on the locations of these base stations, calculate the location of the MS. Alternatively or in addition, the MS may use a Global Positioning System (GPS), if available, in order to determine its location. In either case, very little participation from the wireless network may be required.

The locations of the base stations that may broadcast the downlink signals used for calculating the location of the MS may be provided to the MS from one or more external sources including, for example, from at least one of the base stations. Such information (herein “location information”) may be needed depending on, for example, the technique used for determining the location of the MS. In some embodiments, the location information of the base stations provided to the MS may be updated periodically and may be sent to the MS as encrypted messages by the serving BS as a L2 (second level), a L3 (third level) message, or other types of encrypted messages (i.e., encrypted location information). For these embodiments, a service provider providing the location service (i.e., “navigation service”) may provide the decryption key or keys needed to decrypt the encrypted location information of the base stations. In some embodiments, the navigation service may be a network service provider of the wireless network and may be remotely separate and distinctly disposed from the MS as well as from the base stations.

In some instances, the decryption key or keys may be provided to the MS via the serving BS. The encrypted location information provided to the MS may include location information of the serving BS as well as other neighboring base stations that may transmit the downlink signals, which may be measured by the MS. The MS may then determine its own location by calculating its own location based on the location information decrypted using the decryption key or keys provided by the navigation service, and the downlink signals received from the base stations (i.e., serving and neighboring base stations).

As previously described, a subscriber (i.e., MS) using the navigation service may be required to obtain, in order to determine its own location at any given point in time, the latest location information of the serving BS and neighboring base stations in order to determine its location. That is, and in accordance with various embodiments, the navigation service may broadcast over the course of time and in some instances, at regular time intervals, the location information of the serving and neighboring base stations using different encryption keys. Thus, in order for the MS to be able to properly decrypt the latest encrypted location information of the base stations that will broadcast the downlink signals, the MS may need to obtain the latest decryption key in order to properly decrypt such encrypted location information. Therefore, and in accordance with some embodiments, the service provider may periodically provide to the MS, as well as other MSs who are fully paid subscribers having valid subscription to this service, new decryption key or keys so that the MS (as well as those MSs that have valid subscriptions to this service) may be able to successfully decrypt the latest encrypted location information of the base stations in order to allow the subscriber (i.e., MS) to ultimately determine its location. That is, by using this approach, only those subscribers (i.e., MSs) who have fully paid for and have valid subscriptions for the service (and who will be receiving the latest decryption keys) may be able to successfully decrypt the latest encrypted location information of the base stations needed in order to determine the location of the subscribers.

To illustrate, the following example is provided that depicts how the location or locations of an MS of a wireless network may be determined at different points in time with only minimal intervention from the wireless network (e.g., navigation service), wherein the MS (or the user of the MS) has a valid subscription to the navigation service in accordance with various embodiments of the present invention. Initially, during a first time period or time increment, the MS may obtain, from a navigation service, a decryption key to decrypt encrypted location information of base stations that may indicate the geographical locations of the base stations that will broadcast the downlink signals to be measured and used by the MS for determining the location of the MS.

In addition to the decryption key, the MS may also obtain from a base station (BS), which may be one of the base stations that will transmit the downlink signals, the encrypted location information of the BS. In some embodiments, the BS transmitting such information may be the serving BS for the MS. The encrypted location information obtained by the MS may also include, in addition to the encrypted location information of the serving BS, the encrypted location information of other neighboring base stations that may broadcast downlink signals to the MS. In some embodiments, the encrypted location information may include the longitude and latitude coordinates of the BS and the other neighboring base stations.

The encrypted location information of the BS (as well as the other neighboring base stations) may then be decrypted using the decryption key to recover the location information of the BS (as well as the location information of the other neighboring base stations). After decrypting the encrypted location information, the location of the MS may then be determined by calculating the location based on the decrypted location information of the BS and the other neighboring base stations as well as based on measurements of the downlink signals broadcasted by the BS and the other neighboring base stations.

If the MS, or the user associated with the MS, has a currently valid subscription to the navigation service then during a second time period or increment, the MS may further obtain from the navigation service, another (i.e., a second) decryption key to decrypt encrypted location information. The MS may further obtain from the BS another (i.e., second) encrypted location information of the BS. The second encrypted location information obtained by the MS may also include, in addition to the second encrypted location information of the BS, second encrypted location information of the other neighboring base stations that may broadcast downlink signals to the MS.

The second encrypted location information of the BS (as well as the other neighboring base stations) may then be decrypted using the second decryption key to recover the second location information of the BS (as well as the second location information of the other neighboring base stations). After decrypting the second encrypted location information, the second location of the MS, which may be the same as the initial location of the MS, may then be determined based on the second decrypted location information of the BS and the other neighboring base stations as well as based on measurements of downlink signals broadcasted by the BS and the other neighboring base stations. This process of receiving a new decryption key and using a new decryption key to decrypt encrypted location information of the base stations in order to determine the most recent location of the MS may be repeated over and over again over the course of time so long as the MS (or the user associated with the MS) has a valid subscription to the navigation service.

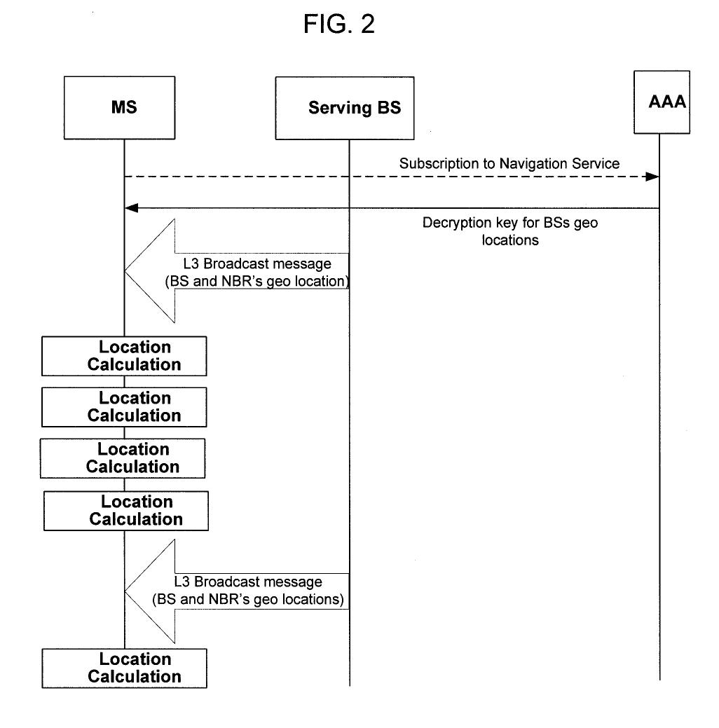

FIG. 2 illustrates how information may be exchange between an MS, a serving base station, and AAA (authentication, authorization, and accounting) as described above, in accordance with various embodiments of the present invention. In this example, a navigation service (i.e., service provider) enables subscribers (e.g., MS) to be able to determine their current geographical locations (geo locations).

As depicted, the MS or a subscriber associated with the MS may subscribe to the navigation service. The servicing base station (or simply “servicing BS”) may broadcast to the MS an encrypted message, which in some instances may be an L3 message, that provides the geographical locations of the serving base station and neighboring base stations (NBR) that may broadcast the downlink signals that may be used for determining the location of the MS. This message may be decrypted by the MS using a decryption key provided by the AAA.

In this scenario, there is minimal involvement and support from the wireless network. Further, and as depicted, the location of the MS may be calculated on a periodic or regular basis—thus four blocks of “location calculation” are shown in FIG. 2. The MS location or locations calculated by the MS may be used by user applications residing at the MS, be sent to network applications or other entities either internal or external to the network, and/or in any manner that the subscriber associated with the MS chooses.

As described earlier, in some alternative embodiments and in contrast to the embodiments described above, a wireless network may play a relatively significant role in the determination of the location of an MS. For these embodiments, the determination of location or locations of an MS may be performed via a navigation service as before. However, and in contrast to the previous embodiments, the determination of location or locations of an MS may be facilitated by a wireless network that includes location agents, one or more location controllers, and one or more location servers, as will be described in greater detail herein.

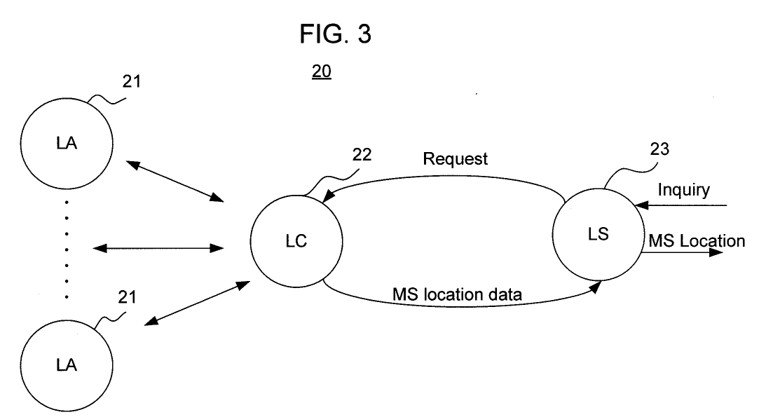

FIG. 3 illustrates an exemplary communication network (“network”) that includes one or more location agents (LAs), a location controller (LC), and a location server (LS) in accordance with various embodiments of the present invention. For the embodiments, each of the LAs 21, the LC 22, and the LS 23, may be remotely disposed from each other in the network 20. In brief, the LS 23 may be the centralized reference function of the network 20 that may accept inquiries from and provides location data of a MS to authorized entities (i.e., “clients”) that may be either internal or external to the network 20. The LC 22 may collect current location measurements of the MS that may be needed for determining the location of the MS. And based on the collected current location measurements, the LC 22 may determine substantially in real time the location of the MS and reporting the current location of the MS back to the LS. The one or more LAs 21, may be responsible for making the current location measurements needed by the LC 22 for determining the location of the MS. In some embodiments, the current location measurements collected by the one or more LAs 21 may be the measurements of downlink and/or uplink signals transmitted by base stations and/or the MS. Alternatively, the current location measurements may be information that indicates the current location of the MS in which case the LC 22 may simply collect the location information of the MS contained in the location measurements and may not be involved in the calculation of the current location of the MS.

In accordance with various embodiments of the present invention, the LS 23 may initially accept a request or an inquiry (herein “inquiry”) for the current location of a MS from a variety of authorized entities, e.g., an application residing in the MS itself, a network application, a regulator/legal entity, an application client on the application server provider (ASP), a functional element inside the NAP/NSP (network access provider/network service provider), and so forth. Based on an MS location request, the LS 23 may trigger procedures within the network 20 that may eventually result in the determination of the current location of the MS. In particular, as a result of the inquiry, the LS 23 may send to the LC 22, which in this case may be the LC serving the MS, a request for the location of the MS.

The LC 22, in response to the request from the LS 23, may determine and report the location of the MS to the LS 23. The location of the MS may be determined by the LC 22 by the LC 22 calculating the location of the MS based on the location measurements provided by one or more LAs 21, or alternatively, the location of the MS may be determined by the one or more LAs 21 in which case the LC 22 simply gathers such information as described before. In order for the LC 22 to obtain the measurements needed to calculate the current MS location (or the actual location data of the MS), the LC 22 may trigger the one or more LAs 21 to take measurements of downlink signals received from base stations (if an LA 21 is residing at the MS) or uplink signals from the MS (if one or more of the LAs 21 is or are residing at the base stations) depending upon the technique employed for determining the location of the MS. The triggering of the one or more LAs 21 to take measurements may be as a result of a request or requests transmitted by the LC 22 to the one or more LAs 21.

The one or more LAs 21 may reside at the MS and/or base stations located near the MS. At least one of the base stations may be the serving base station for the MS while the other base stations may simply be neighboring base stations located relatively near the MS. After determining the location of the MS, the LC 22 may send the determined location of the MS back to the LS 23, which may then report the location of the MS back to the requesting client.

The one or more LAs 21, the LC 22, and the LS 23, depicted in FIG. 3 may be implemented using a combination of software and software. For example, in some embodiments, any network component that has one or more processors and a storage medium for storing programming instructions to be operated by the one or more processors may act as a location agent, a location controller and/or a location server. As previously described, the one or more LAs 21 may be located at the MS and/or at the base stations.

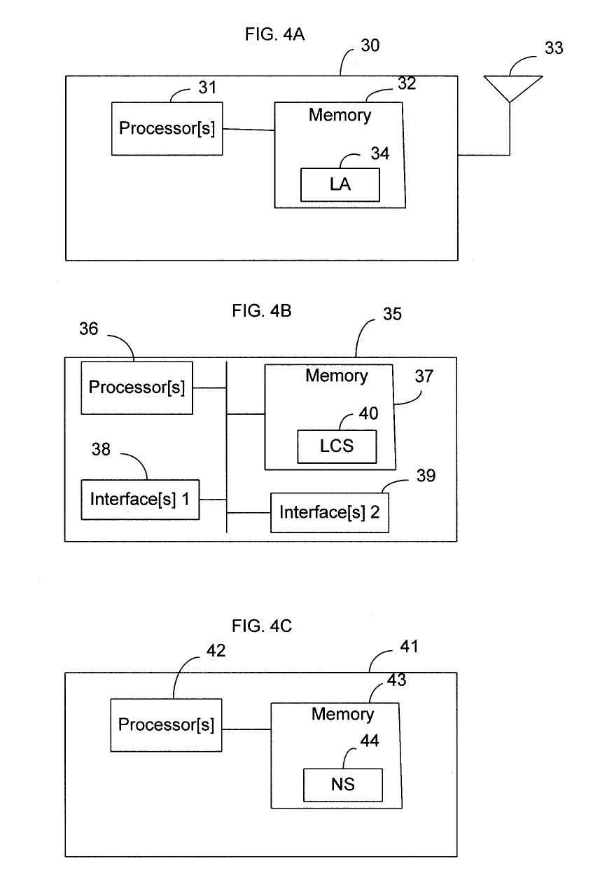

FIG. 4A illustrates an exemplary network device that may host or be adapted to act as a location agent (LA) in accordance with various embodiments of the present invention. The network device 30, in some embodiments, may be an MS or a base station and may include at least one or more processors 31, a memory 32, and one or more antennas 33. The memory 32, in some embodiments, may be a nonvolatile memory such as a mass storage device or flash memory for storing programming instructions (as depicted by reference 34) for performing the functions of a location agent as described herein. The one or more antennas 33 may be one or more omnidirectional or directional antennas.

FIG. 4B illustrates an exemplary network device 35 that may host or be adapted to act as a location controller (LC) in accordance with various embodiments of the present invention. The network device 35 may include one or more processors 36, a memory 37, a first one or more communication interfaces 38, and a second one or more communication interfaces 39, coupled together as shown. The first one or more communication interfaces 38 may be a wireless and/or wireline communication interface for communicating with a location server while the second one or more communication interfaces 39 may be one or more wireless communication interfaces for communicating with a number of location agents. In some embodiments, the memory 37 may be a nonvolatile memory such as a mass storage device or flash memory that may store programming instructions for a location control service 40, which when operated by the one or more processors 36, may perform the functions of the location controller as described herein.

FIG. 4C illustrates an exemplary network device 41 that may host or be adapted to act as a location server (LS) in accordance with various embodiments of the present invention. For the embodiments, the network device 41 includes one or more processors 42 and a memory 43. Although not depicted, the network device 41 may further include one or more communication interfaces that may be wireless or wireline communication interfaces for communicating with clients that may want to obtain the location of an MS and for communicating with one or more location controllers. The memory 43, which may be a storage medium such as a mass storage device or a flash memory device, may store programming instructions for performing navigation service (NS) functions as indicated by reference 44. The navigation service (NS) 44 may be designed to perform functions of the location server as described herein.

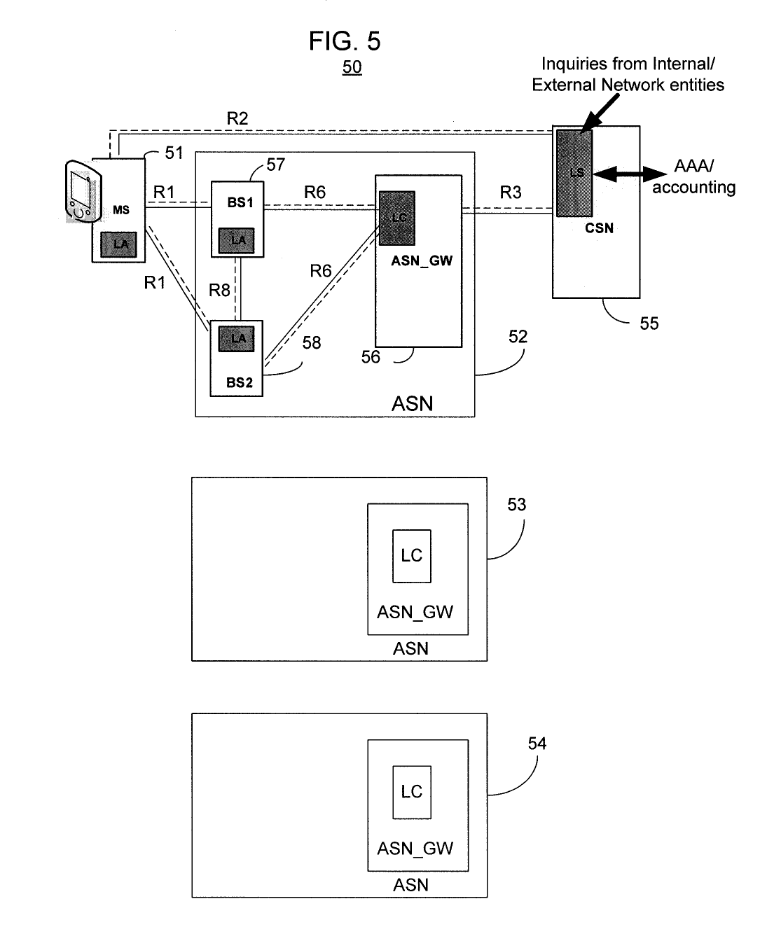

FIG. 5 illustrates an exemplary WiMAX network in accordance with various embodiments of the present invention. As depicted, the WiMAX network 50 (herein “network 50”) includes a mobile station (MS) 51, a first, a second and a third access service network (ASN) 52, 53, and 54, and a connectivity service network (CSN) 55. R1, R2, R3, R6, and R8 refer to different open interfaces of a WiMAX network as is known in the art. For the embodiments, the ASNs 52, 53, and 54 may each include corresponding ASN gateways (ASN_GW). The ASNs 52, 53, and 54 may each further include one or more base stations even though, for purposes of illustration and ease of understanding, only the first ASN 52 in FIG. 5 is depicted as having base stations. As to the first ASN 52, although the first ASN 52 is depicted as, for ease of understanding, having only two base stations (BSs) 57 and 58, the first ASN 52 may, in fact, include additional base stations to facilitate, for example, triangulation techniques described previously to be used for determining the location of the MS 51. In the embodiments represented by FIG. 5, two location agents (LAs) are located at the BSs 57 and 58 while a third location agent (LA) is located at the MS 51.

As further shown in FIG. 5, a location controller (LC) may be located at each of the ASN gateways included in each of the ASNs 52, 53, and 54. Thus, in this network 50, there are multiple location controllers (LCs). However, since only one of the ASNs 52, 53, and 54 may be a serving ASN for MS 51, only one of the location controllers may be the serving LC for MS 51. In this case, the first ASN 52 is the serving ASN, and thus, only the LC located at ASN gateway 56 of the first ASN 52 will be the serving LC. Of course, once MS 51 relocates to a different geographical location, another ASN (e.g., ASN 53 or 54) may become the new serving ASN and its associated LC may become the new serving LC for MS 51.

Located at the CSN 55 is a location server (LS). As previously described, the LS may initiate the process for determining and providing the location of an MS (e.g., MS 51). The trigger event may be an inquiry for the location of the MS 51 sent by a client, such as a user application residing at the MS 51, or an internal or external network entity. Upon receiving the inquiry, the LS may exchange various information with AAA and/or an accounting server to, for example, verify the security options of the subscriber associated with the MS 51, verify that the client is authorized to access the location information of MS 51, verified that the account of the subscriber is good, and so forth, as will be described in greater detail below.

The LS in response to the inquiry for the location of the MS 51 may attempt to determine which of the ASNs 52, 53, and 54 is the serving ASN for MS 51 as well as which of the LCs is the serving LC. After determining the serving LC, the LS may send to the serving LC (in this case, the LC residing at ASN gateway 56), a request for the location of MS 51. In response to the request from the LS, the LC may send to one or more of the LAs located at the base stations 57 and 58 and the MS 51, a request for current location measurements of the MS 51. In various embodiments, the requested current location measurements may be in the form of measurements of downlink signals broadcasted by base stations (e.g., BSs 57 and 58) and received by the MS 51 or uplink signals transmitted by the MS 51 and received by base stations (e.g., BSs 57 and 58). Alternatively, the requested current location measurements may be the actual location of MS 51 measured and calculated by the LAs.

As a result of the request from the LC, the LAs may provide to the LC, the requested current location measurements of MS 51. The LC may then based at least in part on the current location measurements provided by the LAs, determine the current location of MS 51, which is then provided back to the LS. The LS may then send the current location of MS 51 back to the client that originally requested the location of MS 51.

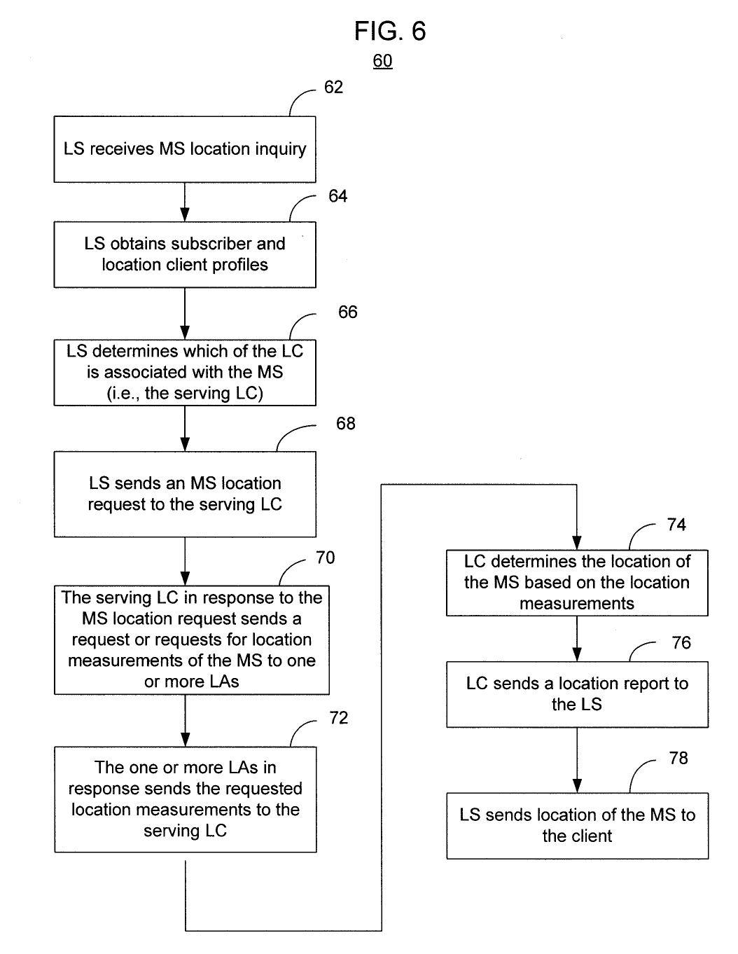

FIG. 6 is a process for determining a location of an MS of a wireless network, in accordance with various embodiments of the present invention. In particular, the process 60 generally corresponds to the previously described process for determining and providing location or locations of an MS of a wireless network.

The process 60 may begin when a location server (LS) receives an inquiry for a current location of the MS at 62. The inquiry may be from a client, such as an application residing at the MS itself, an application client on an application service provider (ASP), a regulatory/legal entity, a functional element inside a NAP/NSP (Network Access Provider/Network Service Provider), an application external or internal to the network, and so forth. The inquiry may include certain information such as the identity of the MS or subscriber associated with the MS, the identity of the requesting entity (i.e., client), desired resolution, periodicity (e.g., how frequently will the location of the MS be reported), latency, duration, and so forth. With respect to the desired resolution, in accordance with various embodiments, it may be possible to obtain different resolution of the location of the MS. For example, if not much resolution is needed, only the location of the serving LC or a location agent (e.g., serving base station) may be provided—the MS will be near the serving LC or the LA, and therefore, such a location will be a relatively low resolution location of the MS.

After the LS receives the inquiry from the client, the LS may then obtain subscriber (i.e., the user associated with the MS) and client profiles at 64. The subscriber profile may include MS device capabilities and security options including whether the device supports GPS, whether the device supports Enhanced WiMAX Location Measurement Capability, verification of subscription to the location based services (level/type), and a list of authorized clients (i.e., clients who are authorized to get location information of the MS). The client profile may be used, at least in part, in order to determine whether the client is authorized to access the MS location information.

After obtaining the subscriber's profile and the authorization of the client to access the location information of the MS has been confirmed, the LS may determine the identity of the serving LC for the MS at 66. Depending on whether the MS is in active mode or idle (i.e., sleep) mode, the process for determining the serving LC may differ. For example, and in brief, if the MS is in active mode, and when the MS relocates to a new location, an inter-ASN handover may occur, in which case, the target ASN may send the identity of the serving LC in the local ASN to the LS. Thus, the LS may always be updated with the identity of the serving LC as long as the MS is in active mode. In contrast, when the MS goes into an idle mode, a paging controller (PC) may be assigned to the MS. Once assigned and every time the MS is relocated, an anchor PC (APC), which may be located at an anchor ASN gateway (ASN_GW), may send the identity of the serving LC in the local or serving ASN to the LS.

After determining the identity of the serving LC, the LS may send a request for the location of the MS to the serving LC at 68. The MS location request may include certain information such as resolution sought, latency, periodicity, location response type (i.e., the type of response or report that the serving LC may eventually provide back to the LS), and so forth. The request may also include the identity of the MS/subscriber, and MS's special location capability as captured in the stored MS profile.

In response to the MS location request, the serving LC may check for the state of the MS (i.e., whether the MS is in an idle or active state) based on the information available in, for example, the local or serving ASN. If the MS is in an idle state, the serving LC may trigger a paging process as performed by a paging controller (PC), which may eventually facilitate the output of the requested location measurements from a location agent residing at the MS, if there is one located at the MS. The serving LC may then send a request or requests for current location measurements of the MS to one or more location agents (LAs) at 70. Such a request or requests may be sent to the one or more LAs contemporaneously in response to the request for the location of the MS from the LS.

The request or requests may cause the one or more LAs to provide the requested current location measurements. In some embodiments, at least one of the LAs may gather such measurements. For these embodiments, the at least one of the LAs may gather the requested current location measurements from a plurality of base stations that may each include a location agent. The at least one of the LAs may additionally or alternatively obtain current location measurements from the MS itself, which may also include a location agent. In response to the request or requests from the serving LC, the one or more LAs may send to the serving LC the requested current location measurements of the MS at 72.

The LC may then determine the location of the MS based on the current location measurements provided by the one or more LAs at 74. As described before, this determination may be as a result of the LC calculating the location of the MS based on the current location measurements provided by the at least one LA if the location measurements are, for example, measurements of downlink and/or uplink signals, or alternatively, if the location measurements are the actual location of the MS, the LC may simply gather the location measurements in order to make the MS location determination. In alternative embodiments, however, the LC may determine and provide to the LS, a location other than the actual location of the MS. That is, if low resolution is all that is required, then the LC may determine that the current location of the MS is, for example, the current location of the LC itself or the current location of one of the LAs (e.g., serving base station).

After determining the current location of the MS, the LC may report back to the LS the current location of the MS in the form of a location report response at 76. The location report response may include the identity of the MS (device/user), location response type, location data (e.g., coordinates), resolution/confidence level, and so forth. After receiving the location report response from the LC, the LS may then send the current location of the MS to the client at 78.

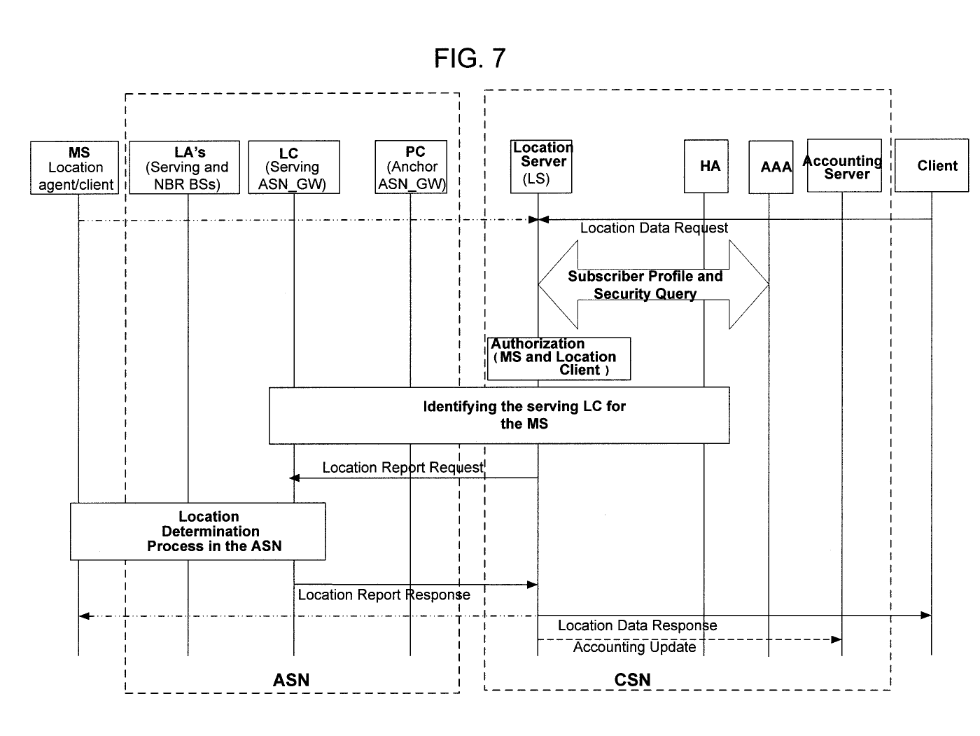

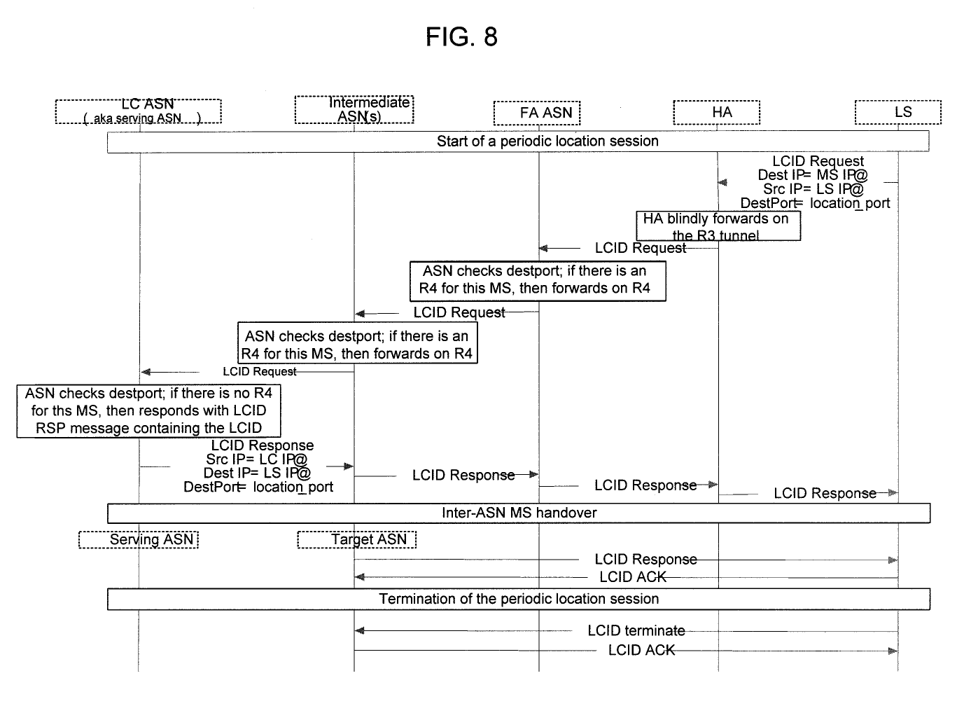

FIG. 7 illustrates a high level call flow for initiating MS location determination, internal triggers, and reports, in accordance with various embodiments of the present invention. In particular, the high level call flow depicted corresponds to the processes described previously. Note that in FIG. 8, NBR stands for “neighboring” while HA stands for home agent.

As described previously, the process for determining the identity of the serving LC (herein “LCID”) by the location server (LS) may differ depending upon whether the MS is in idle or active mode. Further, such a process may depend on whether the inquiry or request for the location of the MS is an MS periodic location request (i.e., a request for the location or locations of an MS at different points in time) or an MS non-periodic location request (i.e., a one time only request).

In some situations such as at the start of a periodic location request or in the case of a non-periodic location request, the LCID may be pulled by the LS. In these situations, the LS may determine the LCID for the MS by sending an LCID request message addressed to the MS (dest IP=MS IP@) to the wireless network. If the MS is in active mode, the message may eventually reach the serving ASN of the MS, which looks at the destination port (destPort) and responds back with the LCID of the MS. On the other hand, if the MS is in idle mode, the message may eventually reach the anchor paging controller (APC) of the MS, which may look at the special destPort, and responds back with the LCID of the MS.

For the case where the location request (i.e., inquiry) is a periodic location request, and after the start of the periodic location request, the LCID may be pushed rather than pulled to the LS. For example, when the MS is in the active mode, and whenever an inter-ASN handover occurs (i.e., when the MS relocates to a new ASN), the new serving LC in the target ASN may update the LS. When idle exit occurs, the LC in the serving ASN may update the LS with the LCID.

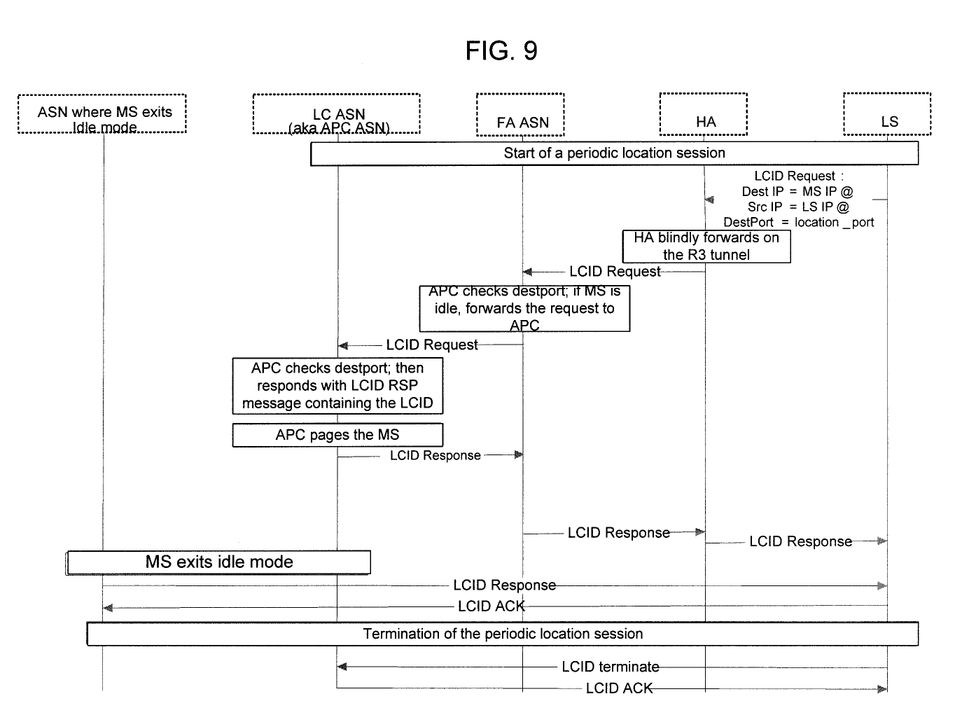

FIG. 8 illustrates how a location server (LS) may be updated with current LCID when the MS is in active (or connected) mode in accordance with various embodiments of the present invention. As the MS relocates to a different location, a request message for the LCID sent by the LS may be passed from the home agent (HA) to the foreign agent (FA), which may then pass the message to the intermediate ASN, and so forth. Referring now to FIG. 9 which illustrates, in contrast, how the LS may be updated with current LCID when the MS is in idle mode.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A method, comprising:
obtaining by a mobile station (MS), from a navigation service remotely disposed from the MS a decryption key to decrypt encrypted location information;
obtaining by the MS, from a base station (BS) remotely disposed from the MS, encrypted location information of the BS, the BS and the navigation service being separate and distinct from each other;
decrypting the encrypted location information of the BS using the obtained decryption key to recover the location information of the BS; and
determining a location of the MS based, at least in part, on the decrypted location information of the BS.

2. The method of claim 1, wherein said obtaining by an MS, from a navigation service, a decryption key to decrypt encrypted location information comprises obtaining by the MS a decryption key from a navigation service of a wireless network.

3. The method of claim 1, wherein said obtaining by the MS, from a BS, encrypted location information of the BS comprises obtaining by the MS, from the BS, encrypted location information of neighboring base stations in addition to the encrypted location of the BS, said decrypting of the encrypted location information of the BS comprises decrypting the encrypted location information of the neighboring base stations, and said determining a location of the MS based, at least in part, on the decrypted location information of the BS comprises determining the location of the MS based on the decrypted location information of the neighboring base stations in addition to the decrypted location information of the BS.

4. The method of claim 1, further comprising receiving by the MS, from the BS, downlink signals in addition to the encrypted location information to the BS to facilitate said determining of the location of the MS.

5. The method of claim 4, further comprising receiving by the MS, downlink signals from other base stations in addition to the downlink signals from the BS to facilitate said determining of the location of the MS.

6. The method of claim 1, wherein said MS has a valid subscription to the navigation service and said determining of the location of the MS is during a first time increment, and the method further comprises:
obtaining by the MS, from the navigation service, another decryption key to decrypt encrypted location information;
obtaining by the MS, from BS, another encrypted location information of the BS;
decrypting the other encrypted location information of the BS using the obtained other decryption key to recover the other location information of the BS; and
determining, during a second time increment, another location of the MS based, at least in part, on the other decrypted location information of the BS.

7. An apparatus, comprising:
one or more processors;
storage medium coupled to the processors, having stored therein programming instructions to be operated by the one or more processors to:
receive, from a location controller (LC) remotely disposed from the apparatus, a request for current location measurements of a mobile station (MS) of a wireless network, remotely disposed from both the LC and apparatus, the LC being associated with the MS;
gather the requested current location measurements of the MS; and
send to the LC, the requested current location measurements of the MS.

8. The apparatus of claim 7, wherein said programming instructions are adapted to be operated by the one or more processors to receive, from the LC, a request for the current location measurements of the MS, when the LC makes the request contemporaneously in response to a request of a location server for the current location of the MS.

9. The apparatus of claim 7, wherein said programming instructions are adapted to be operated by the one or more processors to gather the requested current location measurements of the MS by obtaining the current location measurements from a plurality of base stations.

10. The apparatus of claim 7, wherein said programming instructions are adapted to be operated by the one or more processors to gather the requested current location measurements of the MS by obtaining the current location measurements from the MS.

11. The apparatus of claim 7, wherein said apparatus is the MS.

12. The apparatus of claim 7, wherein said apparatus is a base station.

13. The apparatus of claim 7, wherein said programming instructions are adapted to be operated by the one or more processors to said send to the LC, the requested current location measurements of the MS by sending to the LC, current location measurements of the MS to be used by the LC to calculate the location of the MS.

14. A system, comprising:
a wireline communication interface to communicate with a location server;
one or more wireless communication interfaces to communicate with a plurality of location agents (LAs) remotely disposed from the system;
one or more processors coupled to the communication interfaces; and
a location control service operated by the one or more processors, the location control service adapted to:
receive a request via the wireline communication interface from the location server for a current location of a mobile station (MS) of a wireless network, the MS being remotely disposed from the system and the LA;
request one of the LAs, via the one or more wireless communication interfaces, to provide current location measurements of the MS, the requested LA being associated with the MS;
receive from the requested LA, via the one or more wireless communication interface, the requested current location measurements of the MS;
determine the current location of the MS based at least in part on the received current location measurements of the MS; and
provide to the location server, via the wireline communication interface, the determined current location of the MS.

15. The system of claim 14, wherein said wireless network is a Worldwide Interoperability for Microwave Access (WiMAX), and said location control service is further adapted to receive a request for the current location of the MS from a connectivity service network (CSN).

16. The system of claim 15, wherein said location control service is further adapted to receive a request for the current location of the MS in an access service network (ASN).

17. The system of claim 16, wherein said system is an ASN gateway.

18. The system of claim 14, wherein if the one of the LAs is located at the MS, then said location control service is further adapted to, prior to said requesting the one of the LAs, via the one or more wireless communication interfaces, to provide current location measurements of the MS, to determine if the MS is in an idle state, and if so, to trigger a paging process to facilitate the LA located at the MS to provide current location measurements of the MS.

19. The system of claim 14, wherein said location control service is further adapted to determine the current location of the MS by computing the current location of the MS based, at least in part, on the received current location measurements of the MS.

20. The system of claim 14, wherein said location control service is further adapted to, instead of providing to the location server the current location of the MS, providing a current location of a base station serving the MS.

21. An article of manufacture, comprising:
storage medium;
programming instructions stored in the storage medium, the programming instructions adapted to enable an apparatus to provide a navigation service, including provision of current locations of mobile stations, the navigation service being remotely disposed from the mobile stations and configured to:
receive a location inquiry from a client for a location of a mobile station (MS) of a wireless network,
request a location controller (LC) that is remotely disposed from the apparatus and the MS the location of the MS substantially in real time based on location measurements of the MS obtained from one or more location agents associated with the MS,
receive the determined location of the MS from the LC, and
send the location of the MS to the client.

22. The article of claim 21, wherein said wireless network is a Worldwide Interoperability for Microwave Access (WiMAX), and said instructions are adapted to enable said navigation service to said receive a location inquiry from a client for a location of an MS at a connectivity service network (CSN).

23. The article of claim 22, wherein said instructions are further adapted to enable said navigation service to receive the determined location of the MS from an access service network (ASN).

24. The article of claim 23, wherein said instructions are further adapted to enable said navigation service to receive the determined location of the MS from an ASN gateway.

25. The article of 21, wherein said wireless network comprises a plurality of location controllers (LCs), and said instructions are adapted to enable said navigation service to determine which of the plurality of LCs is the serving LC associated with the MS in order to determine the location of the MS.

26. The article of claim 25, wherein said instructions are adapted to enable said navigation service to determine which of the plurality of location controllers is the serving location controller by sending, in response to the location inquiry, a request for identification of the serving LC to the wireless network.

27. The article of claim 21, wherein said instructions are adapted to enable said navigation service to retrieve a profile of a subscriber associated with the MS to verify, based at least in part on the subscriber profile, whether the client is authorized to receive the location of the MS.
